(19) United States
(12) Patent Application Publication
(10) Pub. No.: US 2023/0234783 A1
(43) Pub. Date: Jul. 27, 2023

(54) Recycling Kiosk for Vaping Devices

(71) Applicant: JT International SA, Geneva (CH)

(72) Inventor: Alec Wright, Guildford (GB)

(73) Assignee: JT International SA, Geneva (CH)

(21) Appl. No.: 18/003,796

(22) PCT Filed: Jun. 29, 2021
(86) PCT No.: PCT/EP2021/067835

§ 371 Date: Dec. 29, 2022

(30) Foreign Application Priority Data
Jul. 14, 2020 (EP) 20185771.1

(51) Int. Cl. B65G 1/137; G07F 7/06; G06Q 10/30; A62C 3/00

(52) U.S. Cl. CPC B65G 1/1371; G07F 7/06; G06Q 10/30; A62C 3/00; B65G 2207/22

(57) ABSTRACT

A recycling kiosk for vaping devices includes a digital link for accessing digital data from a vaping device; at least two storing compartments for storing of vaping devices of different conditions; wherein the recycling kiosk is arranged to store vaping devices in the respective storing compartment based on the digital data accessed from the vaping device. A method for accepting a vaping device by a recycling kiosk is also provided.

### 1. TECHNICAL FIELD

The invention relates to a recycling kiosk for vaping devices, like electronic cigarettes, heat-not-burn products, electronic shishas and the like. The recycling kiosk can be used by a consumer for safely dispensing vaping devices for recycling thereof.

### 2. PRIOR ART

Recycling kiosks are commonly known for returning beverage bottles. Further, some attempts have been made to automatically and conveniently return vaping devices or parts thereof to the manufacturer for recycling.

For example, the document US 2015 0336689 A1 discloses a vending mechanism for the vaping devices. The vending mechanism can receive empty user containers, for example electronic cigarettes, for recycling and provide the discount to the user based on the recycled container. The vending machine identifies the user container electronic cigarette with the help of identification sensors employed to identify various user containers.

Further it may be conceivable that the user sends back used vaping devices to the manufacturer for recycling via a common mail service. However, electronic vaping devices usually comprise a battery, usually re-chargeable Li-Ion-battery, which is poses a risk as it may ignite or explode if damaged. Thus, returning used vaping devices to the manufacturer poses risks.

Thus, it is an object of the present invention to provide a safe way of returning electronic vaping devices to the manufacturer for recycling.

### 3. SUMMARY OF THE INVENTION

The above-mentioned problem is solved by a recycling kiosk for vaping devices comprising a digital link for accessing digital data from a vaping device; at least two storing compartments for storing of vaping devices 100 of different conditions; wherein the recycling kiosk is arranged to store vaping devices in the respective storing compartment based on the digital data accessed from the vaping device.

By the digital link the recycling kiosk is able to access digital data from the vaping device for example data about the make, model, age, hours of use, charging status, battery condition, etc. that allows the recycling kiosk to determine a potential risk from the vaping device. Based on the obtained digital data from the vaping device the recycling kiosk chooses a respective storing compartment from at least two storing compartments. The storing compartments can be provided for vaping devices of different risk classes, for example one compartment for vaping devices with a potentially high risk and one compartment for vaping devices with a potentially low risk. The storing compartments can also be provided to store vaping devices from different manufacturers or of different types.

Preferably, the data link is a USB-data connection. It is preferred to use a USB-data connection as data link since a vaping device frequently comprises a USB port for charging purposes.

Preferably, the USB-data connection comprises a USB cable, which is located within an examination space of the recycling kiosk. Preferably, an examination space is provided, where the user can place the vaping device and connect it to a USB cable to establish a data connection between the vaping device and the recycling kiosk. The examination space can be a compartment within the recycling kiosk that can have an automatic door which opens when the user starts the returning process.

Preferably, the recycling kiosk further comprises a wireless adapter and the data link is a wireless data connection, preferably a Bluetooth connection, a wireless LAN WLAN connection or a near field communication NFC connection. As an alternative to a USB-data connection or additionally thereto a wireless data connection between the vaping device and the recycling kiosk can be established.

Preferably, the recycling kiosk further comprises a processor, wherein the processor analyses the digital data accessed from the vaping device. The processor can be part of any kind of computer or controller.

Preferably, the processor determines the make and/or model of the vaping device and decides if the vaping device can be accepted by the recycling kiosk.

Preferably, the processor determines faults of the vaping device battery from the digital data accessed from the vaping device, preferably faults stored on an EPROM of the vaping device. Thus, the processor can determine a status of the battery based on the faults and can determine the risk potential of the vaping device to treat it accordingly.

Preferably, the recycling kiosk comprising a battery analyzing module that analyzes the condition of the battery of the vaping device and provides condition information. If the vaping device does not have the possibility to determine and store faults of the battery, a battery analyzing module of the recycling kiosk can determine the condition of the battery of the vaping device. Preferably, the battery analyzing module may connect a predetermined load to the battery of the vaping device and measure the de-charging rate of the battery to determine the condition thereof. In another embodiment, the battery analyzing module may charge the battery and measure the charging rate of the battery to the determine the condition thereof.

Preferably, the processor receives condition information from the battery analyzing module and determines one of the storing compartments into which the vaping device is to be stored. The battery condition information obtained by the battery analyzing module is then used by the processor to determine the risk potential of the vaping device to determine in which one of the storing compartments the vaping device is to be stored.

Preferably, one of the storing compartments is a storing compartment for vaping devices with intact battery; and/or wherein one of the storing compartments is a storing compartment for vaping devices that cannot be accepted for recycling. Thus, the storing compartment can be designed according the vaping device stored therein.

Preferably, one of the storing compartments is a storing compartment for vaping devices with damaged battery. This storing compartment separates potentially dangerous vaping devices with damaged battery from the other vaping devices stored. Such separation allows separate recycling of vaping devices with damaged battery by specialized firms and/or with increased security measures.

Preferably, the storing compartment for vaping devices with damaged battery withstands explosions or fire in case a battery unintentionally ignites. Preferably, this storing device comprises fire-proof insulated or reinforced walls to withstand battery fires or battery explosions, particularly Li-Ion battery fires and explosions. Preferably, such storing device can be closed in an air-tight manner to stop the fire of a burning battery or at least prevent that battery fires expand to the recycling kiosk.

The storing compartment for vaping devices that cannot be accepted for recycling can be designed to accept vaping devices of unknown types or from other manufacturers that are sent to general recycling instead to dedicated recycling for known types and brands.

Preferably, each of the storing compartments comprises an automatically controlled compartment door. Thus, based on the determination into which of the compartments the vaping device has to be disposed the recycling kiosk automatically opens the respective compartment door.

Preferably, the recycling kiosk further comprises a conveying means for automatically conveying the vaping device into one of the plurality of storing compartments. The conveying means can automatically convey the respective vaping device into the correct storing compartment.

Preferably, the recycling kiosk further comprises a housing and a mechanical hatch within the housing, wherein the hatch provides access to an examination space within the housing for introducing a vaping device into the examination space.

Preferably, the recycling kiosk further comprises a digital screen. The digital screen can be used to communicate with the user by displaying a user interface. The digital screen can preferably be a touch screen. Alternatively or additionally a key panel may be provided for user inputs.

The above mentioned objective is further met by a method for accepting a vaping device by a recycling kiosk, preferably a recycling kiosk as described above, the method comprising the following steps:

a. opening a mechanical hatch of the recycling kiosk;

b. providing a digital link for accessing digital data from a vaping device;

c. analyzing the digital data accessed from the vaping device;

d. storing the vaping device in one respective storing compartment of at least two storing compartments of the recycling kiosk based on the digital data accessed from the vaping device.

Preferably, the method further comprises the step of analyzing the battery status of the vaping device.

Preferably, the method further comprises the step of reading the ID and/or faults of the battery of the vaping device.

### 4. SHORT DESCRIPTION OF THE DRAWINGS

In the following, preferred embodiments of the invention are disclosed by reference to the accompanying figures, in which shows:

FIG. 1: a schematic side sectional view of a preferred embodiment of a recycling kiosk; and

FIG. 2: a flow diagram of a preferred embodiment of a method for accepting a vaping device by a recycling kiosk.

### 5. DESCRIPTION OF PREFERRED EMBODIMENTS

In the following preferred embodiments of the invention are described with respect to the figures.

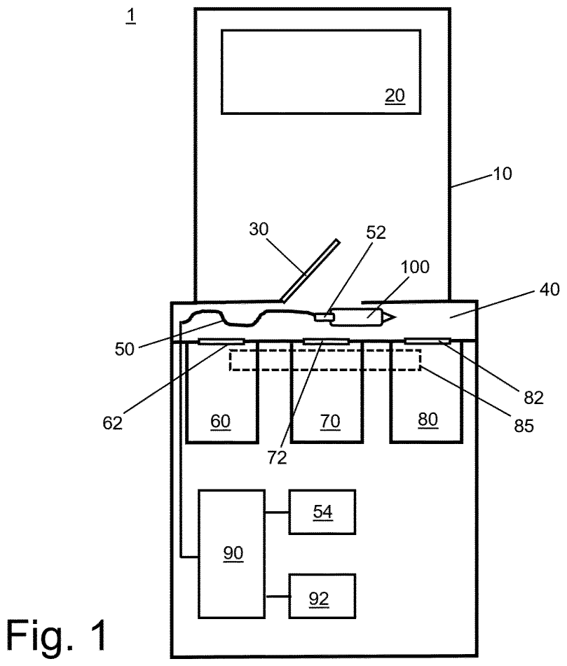

FIG. 1 shows a schematic side sectional view of a preferred embodiment of a recycling kiosk 1. The recycling kiosk 1 can be self-standing like a vending device or can be integrated into a wall. The recycling kiosk 1 is an electronically controlled device for accepting used vaping devices 100 for recycling purposes.

The recycling kiosk 1 comprises a housing 10 preferably of sheet metal. The housing 10 can be opened by service personnel for servicing and couriers for retrieving the collected vaping devices 100.

The housing 1 at its upper portion houses a digital screen 20 for communication with the user. The digital screen 20 may be a touch screen for receiving any user inputs.

The housing 1 comprises a mechanical hatch 30 that provides access to an examination space 40 within the housing 10. A vaping device 100 which is to be returned for recycling can be introduced into the examination space 40. The mechanical hatch may be automatically opened by the recycling kiosk 1 or may be unlocked such that the user can open the hatch 30 manually. The mechanical hatch 30 may be closed during examination of the vaping device 100 to provide security to the user as the vaping device may ignite during battery checks.

If the mechanical hatch 30 is opened the user can place the vaping device 100 into the examination space 40 for automatic examination by the recycling kiosk 1. To this end the recycling kiosk comprises a processor 90 and a battery analyzing module 92. The processor 90 controls the operations of the recycling kiosk 1. For example, the processor 90 controls the display of the digital touch screen 20 and receives any user inputs thereof. Further, the processor may control any electrical or mechanical part of the recycling kiosk 1, like the mechanical hatch 30. The processor 90 may be an industrial controller, an industrial computer, or personal computer based.

The processor 90 analyses digital data accessed from the vaping device loft For example, the processor 90 can determine the make and/or model of the vaping device 100 and can decide if the vaping device 100 can be accepted by the recycling kiosk 1. The processor 90 obtains the digital data from the vaping device 100 via a digital link 50. In the shown embodiment the digital link 50 may be a USB-data connection via a USB cable 50 with a USB connector 52 manually plugged into the vaping device 100 by the user. Alternatively, the data link 50 may be a wireless data connection preferably a Bluetooth connection, a wireless LAN (WLAN) connection or a near field communication (NFC) connection. For a wireless data connection the recycling kiosk 1 comprises a wireless adapter 54 which is connected to the processor 90.

Particularly, the processor 90 can determine faults of the vaping device battery from the digital data accessed from the vaping device 100. Such faulty may preferably be stored on an EPROM of the vaping device 100.

In addition, the battery analyzing module 92 can analyze the condition of the battery of the vaping device 100 and can provide condition information to the processor 90. For doing so the battery analyzing module 92 may comprise a predetermined load, for example a calibrated high-power resistor, to the battery of the vaping device 100 and can measure voltage and current for obtaining the de-charging rate of the battery. This de-charging rate may be a measure to determine the condition of the battery.

In another embodiment, the battery analyzing module 92 may charge the battery of the vaping device 100 and measure measure voltage and current for obtaining the charging rate of the battery to the determine the condition thereof.

The recycling kiosk 1 further comprises at least two storing compartments 60, 70, 80 within the housing 10 for storing of vaping devices 100 of different conditions. In the shown embodiment the recycling kiosk 1 comprises three storing compartments 60, 70, 80. The storing compartment 60 is intended for storing vaping devices 100 with damaged battery. This storing compartment 60 may be provided with fire-proof walls and a fire-proof compartment door 62, in case a vaping device stored therein may ignite. The storing compartment 70 is intended for storing vaping devices 100 with intact battery. The storing compartment 80 is intended for storing vaping devices 100 that cannot be accepted for recycling by the provider of the recycling kiosk but are nevertheless accepted for general recycling

Based on the digital data accessed from the vaping device 100 the processor 90 can decide if and to which one of the respective storing compartments 60, 70, 80 the vaping device is stored. In addition, the processor 90 can select the respective storing compartment 60, 70, 80 based on the battery condition of the vaping device loft If the battery comprises faults, which were determined by the vaping device 100 itself and stored in a memory of the vaping device 100, for example in an EPROM of the vaping device, the storing compartment 60 for vaping devices 100 with damaged batteries is selected. The same storing compartment 60 may be selected by the processor 90 if the battery analyzing module 92 provides condition information of the vaping device battery that indicates a fault of the battery.

In one embodiment of the recycling kiosk 1 each of the storing compartments 60, 70, 80 comprises an automatically controlled compartment door 62, 72, 82. The respective compartment door 62, 72, 82 opens if the processor 90 has selected one of the compartments 60, 70, 80 for the current vaping device loft The compartment doors 62, 72, 82 may automatically open or may be automatically unlocked for opening by the user to place the vaping device wo into the respective compartment 60, 70, 80.

In another embodiment the recycling kiosk 1 comprising a conveying means 85 for automatically conveying the vaping device 100 into one of the plurality of storing compartments 60, 70, 80. The processor 90 controls the conveying means 85 to convey the vaping device 100 into the selected storing compartment 60, 70, 80.

Thus, the storing compartments 60, 70, 80 contain received vaping devices 100 of different properties and can be recycled differently, for example by different companies. Further, the risks are minimized, since vaping devices 100 with a higher risk due to a faulty battery can be stored separately from vaping devices 100 having no such risk. This pre-selection by the recycling kiosk 1 also allows to use different couriers to empty the individual storing compartments 60, 70, 80. For example, a common mail service courier may empty the storing compartments 70, 80, whereas a special courier for higher risky transports may empty the storing compartment 60 for vaping devices 100 with faulty battery. This avoids transportation risks.

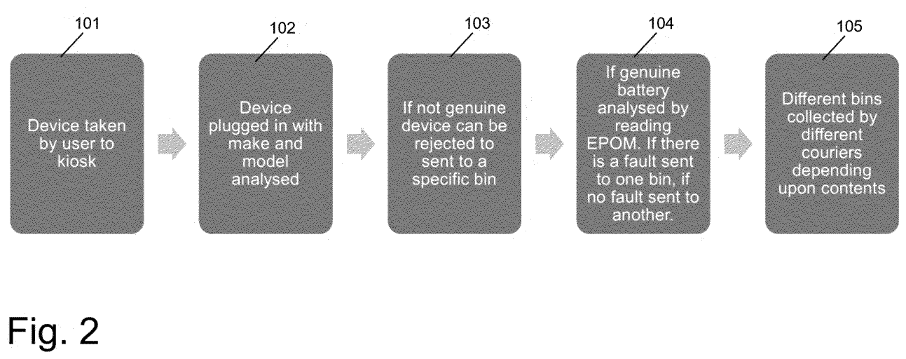

FIG. 2 shows a sequence diagram for the process of returning a vaping device by means of a recycling kiosk 1. In a first step 101 the user takes a vaping device 100 to the recycling kiosk 100. The user may obtain a financial or material refund for returning a used vaping device 100. The recycling kiosk 1 may invoke a transfer of money to a user's bank account, may print out a voucher or coupon or may refund money directly.

In a second step 102 the user connects the vaping device 100 with the data connection 50, preferably a USB-cable 50 of the recycling kiosk 1. Then the processor 90 analyses the make and model of the vaping device 100 based on the received digital data.

In a step 103 the vaping device 100 can be rejected if it is not genuine to the provider of the recycling kiosk 1. Then the current vaping device 100 may be sent to the storing compartment or bin 80 or the user may take it home again.

If the vaping device 100 is genuine the battery condition is analyzed in step 104. This is preferably done by reading out battery fault data that may be stored in an EPROM of the vaping device 100. If a battery fault is detected then the current vaping device 100 is sent to the storing compartment or bin 60, if no battery fault is detected then the vaping device 100 is sent to the storing compartment or bin 70.

In step 105 the content of the different storing compartments or bins 60, 70, 80 is collected by different couriers. As described above, the vaping devices 100 with battery faults collected in storing compartment or bin 60 may treated with particular security to avoid or cope with ignition of the batteries.

A method for accepting a vaping device 100 by a recycling kiosk 1 comprises the following steps:
a. opening a mechanical hatch 30 of the recycling kiosk 1;
b. providing a digital link 50 for accessing digital data from a vaping device 100;
c. analyzing the digital data accessed from the vaping device 100;
d. storing the vaping device 100 in one respective storing compartment 60, 70, 80 of at least two storing compartments 60, 70, 80 of the recycling kiosk 1 based on the digital data accessed from the vaping device loft

The method may further comprise the step of analyzing the battery status of the vaping device loft

In a further step the ID and/or faults of the battery of the vaping device 100 may be read out.

### LIST OF REFERENCE SIGNS

1 recycling kiosk

10 housing

20 digital screen

30 mechanical hatch

40 examination space

50 digital link

52 USB connector

54 wireless adapter

60 storing compartment

62 compartment door

70 storing compartment

72 compartment door

80 storing compartment

82 compartment door

85 conveying means

90 processor

92 battery analyzing module

100 vaping device

101-105 method steps

1. A recycling kiosk for vaping devices comprising:
a digital link for accessing digital data from a vaping device;
at least two storing compartments for storing of vaping devices of different conditions;
wherein the recycling kiosk is arranged to store vaping devices in the respective storing compartment based on the digital data accessed from the vaping device.

2. The recycling kiosk according to claim 1, wherein the data digital link is a USB-data connection.

3. The recycling kiosk according to claim 2, wherein the USB-data connection comprises a USB cable, which is located within an examination space of the recycling kiosk.

4. The recycling kiosk according to claim 1, wherein the recycling kiosk further comprises a wireless adapter and the digital link is a wireless data connection.

5. The recycling kiosk according to claim 1, further comprising a processor, wherein the processor analyses the digital data accessed from the vaping device.

6. The recycling kiosk according to claim 5, wherein the processor is configured to determines the make and/or model of the vaping device and decide whether the vaping device can be accepted by the recycling kiosk.

7. The recycling kiosk according to claim 5, wherein the processor is configured to determines faults of the vaping device battery from the digital data accessed from the vaping device.

8. The recycling kiosk according to claim 1, further comprising a battery analyzing module configured to analyzes a condition of a battery of the vaping device and provides condition information.

9. The recycling kiosk according to claim 8, wherein the processor is configured to receives condition information from the battery analyzing module and determines one of the at least two storing compartments into which the vaping device is to be stored.

10. The recycling kiosk according to claim 1,
wherein one of the at least two storing compartments is a storing compartment for vaping devices with an intact battery; and/or
wherein one of the at least two storing compartments is a storing compartment for vaping devices that cannot be accepted for recycling.

11. The recycling kiosk according to claim 1, wherein one of the at least two storing compartments is a storing compartment for vaping devices with a damaged battery.

12. The recycling kiosk according to claim 11, wherein the storing compartment for vaping devices with a damaged battery withstands explosions or fire in case a battery unintentionally ignites.

13. The recycling kiosk according to claim 1, wherein each of the at least two storing compartments comprises an automatically controlled compartment door.

14. The recycling kiosk according to claim 1, further comprising a conveying means for automatically conveying the vaping device into one of the at least two storing compartments.

15. The recycling kiosk according to claim 1, further comprising a housing and a mechanical hatch within the housing, wherein the hatch provides access to an examination space within the housing for introducing a vaping device into the examination space.

16. The recycling kiosk according to claim 1, further comprising a digital screen.

17. A method for accepting a vaping device by a recycling kiosk, the method comprising:
a. opening a mechanical hatch of the recycling kiosk;
b. providing a digital link for accessing digital data from a vaping device;
c. analyzing the digital data accessed from the vaping device;
d. storing the vaping device in one respective storing compartment of at least two storing compartments of the recycling kiosk based on the digital data accessed from the vaping device.

18. The recycling kiosk according to claim 4, wherein the wireless data connection is a Bluetooth connection, a wireless LAN (WLAN) connection or a near field communication (NFC) connection.
